(19) United States
(12) Patent Application Publication
(10) Pub. No.: US 2007/0098463 A1
(43) Pub. Date: May 3, 2007

(54) Color registration compensation apparatus and method for electro-photographic image forming device

(75) Inventors: Sang-sin Park, Suwon-si (KR); Chang-kyung Ko, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/514,243

(22) Filed: Sep. 1, 2006

(30) Foreign Application Priority Data
Oct. 29, 2005 (KR) 2005-0102650

(51) Int. Cl. G03G 15/01

(52) U.S. Cl. 399/301

(57) ABSTRACT

Provided is a color registration compensation apparatus and method for an electro-photographic image forming apparatus. The color registration compensation apparatus for an electro-photographic image forming apparatus including an exposing unit for forming a plurality of latent images of patterns onto photoconductive drums, wherein at least two of the latent images are comprised of different colors; a developing unit for developing the latent images of the patterns; a pattern sensing unit for sensing the patterns transferred onto a transfer belt after the development; and a color registration control unit for calculating position information data each time the patterns are sensed, for calculating a deviation between the position information data and a set value, for calculating a color registration compensation value using the position information data when the deviation is equal to or less than a threshold value, and for then controlling exposure start timings.

### CROSS-REFERENCE TO RELATED PATENT APPLICATION

This application claims the benefit under 35 U.S.C. §119(a) of Korean Patent Application No. 10-2005-0102650, filed on Oct. 29, 2005, in the Korean Intellectual Property Office, the entire disclosure of which is hereby incorporated by reference.

### BACKGROUND OF THE INVENTION

1. Field of the Invention

The present invention relates to an electro-photographic image forming apparatus such as a laser printer. More particularly, the present invention relates to a color registration compensation apparatus and method which can accurately calculate a color registration compensation value despite defects that are generated in an image forming apparatus that result from the compensation of the color registration.

2. Description of the Related Art

Among electro-photographic image forming apparatuses, such as a color laser printer, are a tandem type image forming apparatus. A tandem type image forming apparatus includes developing units and photoconductive drums that correspond to colors and form an image through a single pass.

The tandem type image forming apparatus includes four photoconductive drums, an exposing unit, developing units and a transfer belt. Each of four photoconductive drums corresponds to one of yellow, cyan, magenta, and black colors. The exposing unit scans light onto each photoconductive drum to form an electrostatic latent image corresponding to an image which a user wants to print.

Each of the developing units develops the electrostatic latent image formed by the exposing unit using a developing solution per color. The transfer belt receives and sequentially superimposes the images developed on the photoconductive drums to form a complete color image, and then transfers the color image onto paper.

Therefore, in order to accurately print a color image, start positions and end positions where the images of four colors are transferred from the photoconductive drums to the transfer belt should coincide. Therefore, in order to accurately print a color image, it is important to accurately control the exposure start timing with respect to each photoconductive drum in consideration of the speed of the transfer belt. This process is a color registration.

Although the exposure start timing is accurately set in an initial stage, mis-registration can be gradually occur as printing is performed because the driving roller operating the transfer belt expands due to the heat caused by printing.

That is, when the driving roller expands such that a diameter thereof is changed, the speed of the transfer belt is changed despite the driving roller rotating the same the number of rotations. Therefore, exposure needs to be controlled based on the exposure start timing. Thus, to accurately realize a desired color image by dynamically controlling the exposure start timing, color registration compensation, that is, compensation for a mis-registration, is required.

Conventionally, in color registration compensation, predetermined patterns are formed on the photoconductive drums by the exposing unit, developed, transferred onto the transfer belt, and detected through a light sensor having a light emitting unit and a light receiving unit. Then, mis-registrations between patterns of colors are obtained to calculate compensation values, thereby re-controlling the exposure start timing of each color.

However, in the conventional color registration compensation method, if instrumental jitter, slip, or right or left weaving is generated when a pattern is printed or sensed, the results of the color registration compensation may be incorrect because the color registration compensation value is calculated based on the position information having no errors.

Accordingly, there is a need for an improved color registration compensation apparatus and method.

### SUMMARY OF THE INVENTION

Exemplary embodiments of the present invention address at least the above problems and/or disadvantages and provide at least the advantages described below. Accordingly, an aspect of the present invention is to provide a color registration compensation apparatus and method which can correctly calculate registration compensation values and perform color registration compensation regardless of instrumental errors that occurred during the color registration compensation.

According to an aspect of the present invention, there is provided a color registration compensation apparatus for an electro-photographic image forming apparatus, the color registration compensation apparatus including an exposing unit for forming a plurality of latent images of patterns onto photoconductive drums, wherein at least two of the latent images are comprised of different colors; a developing unit for developing the latent images of the patterns; a pattern sensing unit for sensing the patterns transferred onto a transfer belt after the development; and a color registration control unit for calculating position information data each time the patterns are sensed, for calculating a deviation between the position information data and a set value, for calculating a color registration compensation value using the position information data when the deviation is equal to or less than a threshold value, and for then controlling exposure start timings.

The color registration control unit may control the exposing unit to reform the patterns when the deviation is greater than the threshold value.

The position information data may include position information data in a main scanning direction and position information data in a subsidiary scanning direction.

The color registration control unit may include a position information data calculating unit for calculating position information data each time the patterns are sensed; a deviation calculation unit for calculating a deviation between the position information data and a set value; a comparison unit for comparing the deviation and a threshold value; a compensation value calculating unit for calculating a color registration compensation value using the position information data when the deviation is equal to or less than the threshold value based on the comparison result; and an exposure start timing control unit for controlling the exposure start timings according to the color registration compensation value.

The color registration control unit may further include: a compensation value storing unit for storing the calculated color registration compensation value, wherein the color registration control unit controls the exposure start timings according to the previous color registration compensation value stored in the compensation value storing unit when the total comparing count of the comparison unit is equal to a threshold comparing count.

The plurality of latent images comprise yellow, magenta, cyan, and black latent images.

According to another aspect of the present invention, there is provided a color registration compensation method for an electro-photographic image forming apparatus, the method including forming a plurality of latent images of patterns onto photoconductive drums, wherein at least two of the latent images are comprised of different colors; developing the latent images of the patterns formed on the photoconductive drums and transferring the patterns to the transfer belt; sensing the patterns transferred to the transfer belt; and calculating position information data each time the patterns are sensed, calculating a deviation between the position information data and a set value, calculating a color registration compensation value using the position information data when the deviation is equal to or less than a threshold value, and then controlling exposure start timings.

In the controlling of the exposure start timings, when the first deviation is greater than the threshold value, the latent images are formed.

The position information data may include position information data in a main scanning direction and position information data in a subsidiary scanning direction.

The controlling of the exposure start timings may include: calculating the position information data each time the patterns are sensed; calculating a first deviation between the position information data and a set value; comparing the first deviation and a threshold value; calculating a color registration compensation value when the first deviation is equal to or less than the predetermined threshold value based on the comparison results; and controlling the exposure start timings according to the color registration compensation value.

The controlling of the exposure start timings may further include: controlling the exposure start timings according to the previous color registration compensation value when the total comparing count is equal to the threshold comparing count.

When the total comparing count is equal to a threshold comparing count, the controlling of the exposure start timings may further include: calculating a second deviation between an average of the position information data and the set value; comparing the second deviation with the threshold value; and calculating a color registration compensation value using the position information data when the second deviation is equal to or less than the threshold value based on the comparison result.

The controlling of the exposure start timings may further include controlling the exposure start timings according to the previous color registration compensation value when the second deviation is greater than the threshold value.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a configuration of a color registration compensation apparatus in an electro-photographic image forming apparatus according to an embodiment of the present invention;

FIG. 2 is a perspective view of an electro-photographic image forming apparatus including a color registration compensation apparatus according to an embodiment of the present invention;

FIG. 3 is a block diagram illustrating a detailed configuration of a color registration control unit in the color registration compensation apparatus of FIG. 1;

FIG. 4 shows an example of patterns used for a color registration compensation apparatus according to an embodiment of the present invention;

FIG. 5 shows timing diagrams of a detection control signal and a pattern sensing unit output signal with respect to patterns of one color, according to an embodiment of the present invention;

FIG. 6 is flowchart illustrating a color registration compensation method for an electro-photographic image forming apparatus, according to an embodiment of the present invention; and

FIG. 7 is flowchart illustrating a color registration compensation method for an electro-photographic image forming apparatus, according to another embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Hereinafter, a color registration compensating apparatus and method for an electro-photographic imaging forming apparatus according to exemplary embodiments of the present invention will be described more fully with reference to the accompanying drawings.

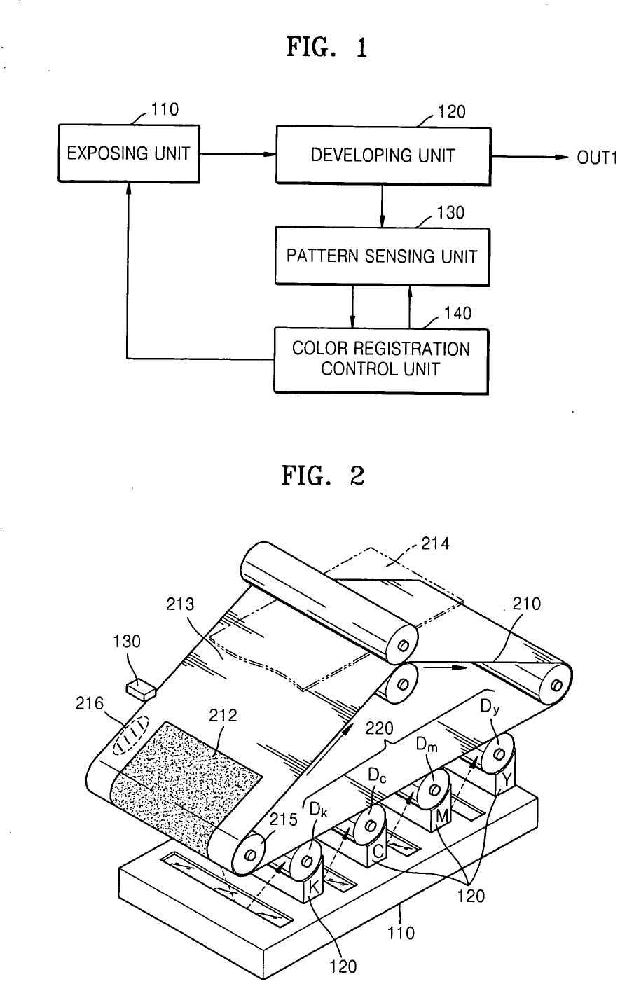

FIG. 1 is a block diagram illustrating the configuration of a color registration compensation apparatus in an electro-photographic image forming apparatus according to an embodiment of the present invention. Referring to FIG. 1, the color registration compensation apparatus includes an exposing unit 110, a developing unit 120, a pattern sensing unit 130, and a color registration control unit 140.

FIG. 2 is a perspective view of the electro-photographic image forming apparatus including the color registration compensation apparatus of FIG. 1. The exposing unit 110 forms images on photoconductive drums 220 corresponding to each color unit. The exposing unit 110 may scans light onto the rotating photoconductive drums 220.

The exposing unit 110 may include a plurality of exposers. The exposers are each installed corresponding to a respective color unit. Similarly, the developing unit 120 may include a plurality of developers and the developers are each installed corresponding to a respective color unit. Thus, hereinafter, the exposing unit 110 may be a group of exposers or a single exposer and the developing unit 120 may be a group of developers or a single developer.

The color units used in this apparatus may be for yellow (Y), magenta (M), cyan (C), and black (K). The photoconductive drums 220 are each installed corresponding to a respective color unit. The developing unit 120 is installed under the photoconductive drums 220. The exposing unit 110 scans light onto the photoconductive drums 220 with a time difference that corresponds to each respective color unit. More specifically, the exposing unit 110 scans light onto the photoconductive drums 220 in the order of Dy, Dm, Dc, and Dk shown in FIG. 2.

When the exposing unit 110 scans light onto the photoconductive drums 220 to form a predetermined image, latent images, that is, electrostatic latent images, corresponding to the predetermined image are formed on the surfaces of the photoconductive drums 220.

The exposing unit 110 scans light to form patterns 216 for performing color registration before scanning light to form a target image onto the photoconductive drums 220. The target image corresponds to an image which a user wants to print, and the patterns 216 are formed of identification marks.

The developing unit 120 develops the latent images of an image formed on the photoconductive drums 220. The image may be the target image or patterns 216. Meanwhile, since the photoconductive drums 220 and the developing unit 120 are installed corresponding to each color, the latent images of the target image or the patterns 216 developed on each of the photoconductive drums 220 is developed corresponding to each color unit. That is, the latent image of the target image or the patterns 216 are developed in one color from among Y, M, C, and K. The transfer belt 210 is moved by the rotation of a driving roller 215, and the latent images developed by the developing unit 120 are transferred onto the transfer belt 210. A region on the transfer belt 210 where the latent images are transferred is an image region 212 and a region on the transfer belt 210 where the latent images are not transferred is a non-image region 213. The pattern 216 may be transferred onto the non-image region 213. In FIG. 2, the exposing unit 110 scans light first on Dy of the photoconductive drums 220 and last on Dk of the photoconductive drums 220. Accordingly, the latent images formed on respective photoconductive drums 220 corresponding to each color by the exposing unit 110 are developed by the developing unit 120. Immediately after being developed, the latent images are superimposed on one another on the surface of the transfer belt 210.

Only when the color registration is accurately performed, are the latent images formed on photoconductive drums 220 accurately superimposed on one another such that a user can obtain a substantially exact print material of the image which the user wanted to print. Developed latent images superimposed on one another on the surface of the transfer belt 210 are pressed onto print paper 214 to print as a print material.

The pattern sensing unit 130 senses the pattern formed by the exposing unit 110. The pattern sensing unit 130 includes a light emitting unit (not illustrated) and a light receiving unit (not illustrated).

The color registration control unit 140 calculates position information data from the time when the pattern sensing unit 130 senses the pattern, and controls the drive of the exposing unit 110 corresponding to each color unit, according to the position information data.

When the color registration control unit 140 controls the exposing unit 110 to drive it, the exposing unit 110 scans light onto the photoconductive drums 220 corresponding to each color unit to form latent images of an image which the user wants to print on the photoconductive drums 220. The latent images formed on the photoconductive drum 220 are developed and transferred onto the surface of the transfer belt 210, and thus the transferred image is printed as a print material 214. Accordingly, only when the color registration control unit 140 drives the exposing unit 110, the exposing unit 110 scans light onto the photoconductive drum 220 for forming an image which the user wants to print on the photoconductive drum 220. OUT1, as illustrated in FIG. 1, represents an image developed by the developing unit 120 when the color registration control unit 140 drives the exposing unit 110.

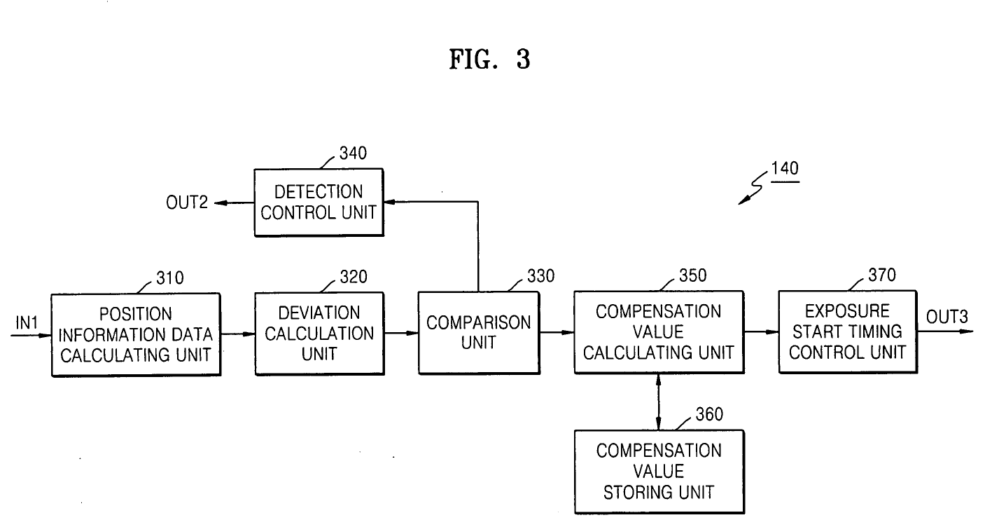

Referring to FIG. 3, the operation of the color registration control unit 140 will be described in detail.

FIG. 3 is a block diagram illustrating a detailed configuration of the color registration control unit 140 in color registration compensation apparatus of FIG. 1. Referring to FIG. 3, the color registration control unit 140 includes a position information data calculating unit 310, a deviation calculation unit 320, a comparison unit 330, a detection control unit 340, a compensation value calculating unit 350, a compensation value storing unit 360, and an exposure start timing control unit 370.

The position information data calculating unit 310 calculates position information data from visual information IN1 outputted from the pattern sensing unit 130. The deviation calculation unit 320 calculates a deviation between the position information data calculated in the position information data calculating unit 310 and a set value of the interval of the patterns to be formed on the surface of the transfer belt 210.

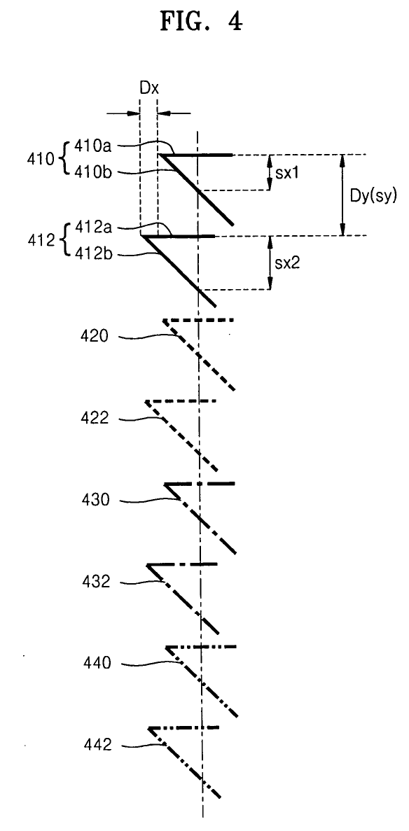

FIG. 4 shows an example of patterns used for a color registration compensation apparatus according to an embodiment of the present invention. Referring to FIG. 4, patterns of Y, M, C, and K are formed on the surface of the transfer belt 210. Each color has two patterns, that is, yellow patterns 410 and 412, magenta patterns 420 and 422, cyan patterns 430 and 432, or black patterns 440 and 442. Each pattern has two marks. For example, the yellow pattern 410 has two marks 410a and 410b, and the other yellow pattern 412 has two marks 412a and 412b. The marks 410a and 412a are horizontal and the marks 410b and 412b are inclined. The angle between the horizontal marks and the inclined marks are at 45°. Reference characters Dx and Dy represent set values of intervals between the patterns of the main scanning direction and the subsidiary scanning direction. The second patterns 412, 422, 432, and 442 are printed onto positions ahead a first distance Dx from positions of the first patterns 410, 420, 430, and 440. The first patterns 410, 420, 430, and 440 and the second patterns 412, 422, 432, and 442 are printed with a second distance Dy. Reference characters sx1, sx2, and sy represent position information data obtained from signals sensed by the pattern sensing unit 130. Since the horizontal mark 410a and the inclined mark 410b are disposed at an angle of 45° with respect to each other, if the color registration is accurate, the position information data sx2-sx1 is equal to the set value Dx.

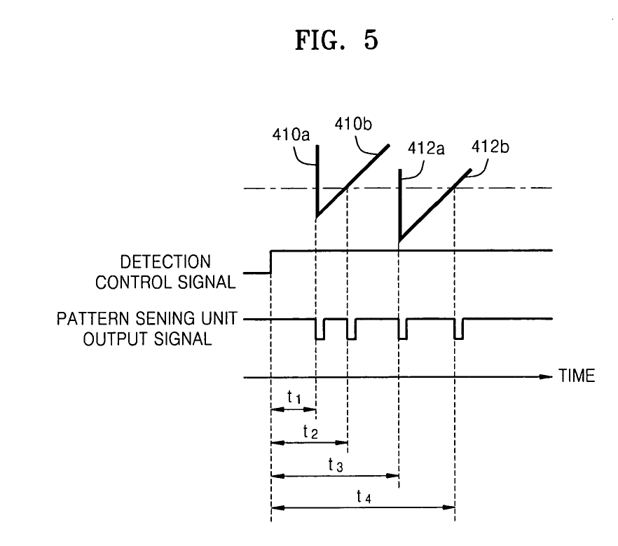

FIG. 5 shows timing diagrams of a detection control signal and a pattern sensing unit output signal with respect to a pattern for one color, according to an embodiment of the present invention. FIG. 5 illustrates signals corresponding to the yellow patterns 410 and 412 of FIG. 4. Referring to FIG. 5, the detection control signal OUT2 is generated by the detection control unit 340 and is transmitted to the pattern sensing unit 130. The pattern sensing unit output signal is a signal on the time axis in which each visual information sensed by the pattern sensing unit 130 is indicated. Each of time lengths t1 through t4 indicate the length of time when each mark 216, as illustrated in FIG. 2, is sensed. Position information calculated from the visual information of t2-t1 is sx1. Position information calculated from the visual information of t4-t3 is sx2. Position information calculated from the visual information of t3-t1 is sy.

The deviation calculation unit 320 calculates a deviation between the set value Dx and the position information data of sx2-sx1 in the main scanning direction, and a deviation between the set value Dy and the position information data sy in the subsidiary scanning direction.

The comparison unit 330 compares the deviations calculated in the deviation calculation unit 320 and threshold values. The threshold values may be, for example, 2 dots. The comparison unit 330 compares the deviations and the threshold values with respect to the main scanning direction and subsidiary scanning direction.

Based on the comparison results of the comparison unit 330, if the deviation is greater than the threshold value, the detection control unit 340 controls the operation of mark sensing unit 130. Reference character OUT2 represents an operation control signal of the detection control unit 340 for the operation of the mark sensing unit 130. As described above, the mark sensing unit 130 receives the operation control signal OUT2 from the detection control unit 340 and senses the pattern 216.

Based on the comparison results of the comparison unit 330, if the deviation is equal to or less than the threshold value, the compensation value calculating unit 350 calculates a compensation value using the position information data.

The compensation value storing unit 360 stores the calculated color registration compensation value. If the total comparing count performed by the comparison unit 330 is equal to a threshold comparing count, the color registration compensation value stored in the compensation value storing unit 360 is used to control the exposure start timing. The comparing count does not indicate a count corresponding to each color, but a comparison count of forming and sensing entire patterns.

The exposure start timing control unit 370 adjusts the exposure start timing of the exposing unit 110 according to the color registration compensation value. Reference character OUT3 represents an exposure start timing control signal corresponding to the exposing unit 110 of the exposure start timing control unit 370.

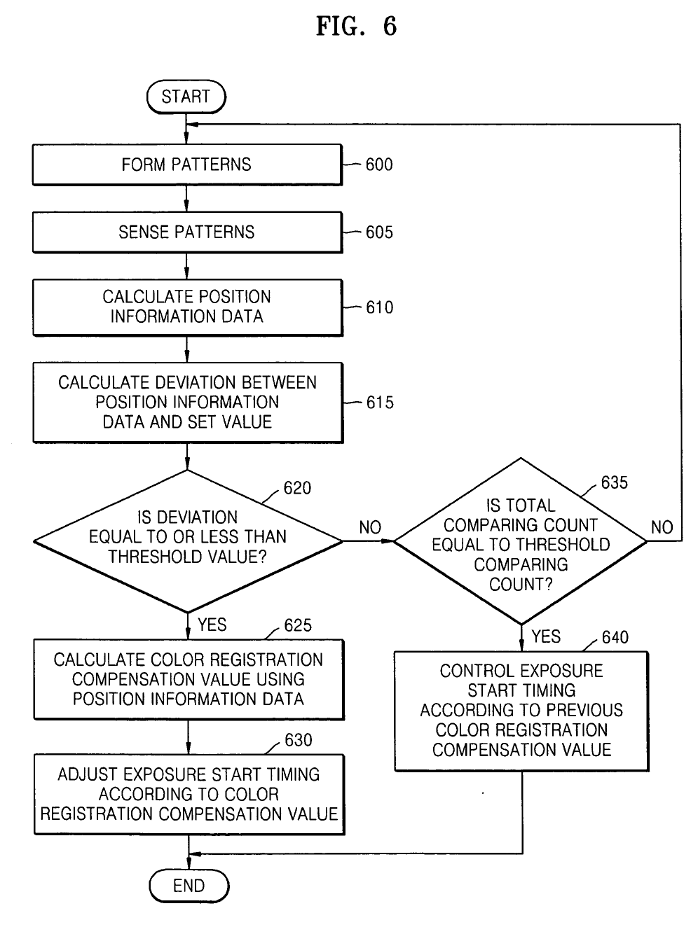

FIG. 6 is flowchart illustrating a color registration compensation method for an electro-photographic image forming apparatus, according to an embodiment of the present invention. The flowchart in FIG. 6 will be described with reference to FIGS. 2 and 3.

Referring to FIGS. 2, 3 and 6, light is scanned onto the surfaces of the photoconductive drums 220 to form patterns in operation 600. The latent image of the patterns are developed and transferred onto the surface of the transfer belt 210. Accordingly, the patterns 216 are formed on the surface of the transfer belt 210.

The patterns 216 formed on the surface of the transfer belt 210 are sensed in operation 605.

Position information data is calculated from the sensed visual information signal in operation 610. Referring to FIGS. 4 and 5, the position information data is calculated in the above-described manner.

A deviation between the position information data and the set value is calculated in operation 615. If the deviation is equal to or less than the threshold value as determined in operation 620, the color registration compensation value is calculated using the position information data in operation 625. The exposure start timing is then adjusted according to the color registration compensation value in operation 630.

If the deviation is greater than the threshold value in operation 620, it is determined if the total comparing count is equal to the threshold comparing count in operation 635. If the total comparing count is not equal to the threshold comparing count in operation 635, operation 600 is performed again until the total comparing count is equal to the threshold comparing count.

In operation 635, if the total comparing count is equal to the threshold comparing count, the exposure start timing is controlled according to the previous color registration compensation value in operation 640.

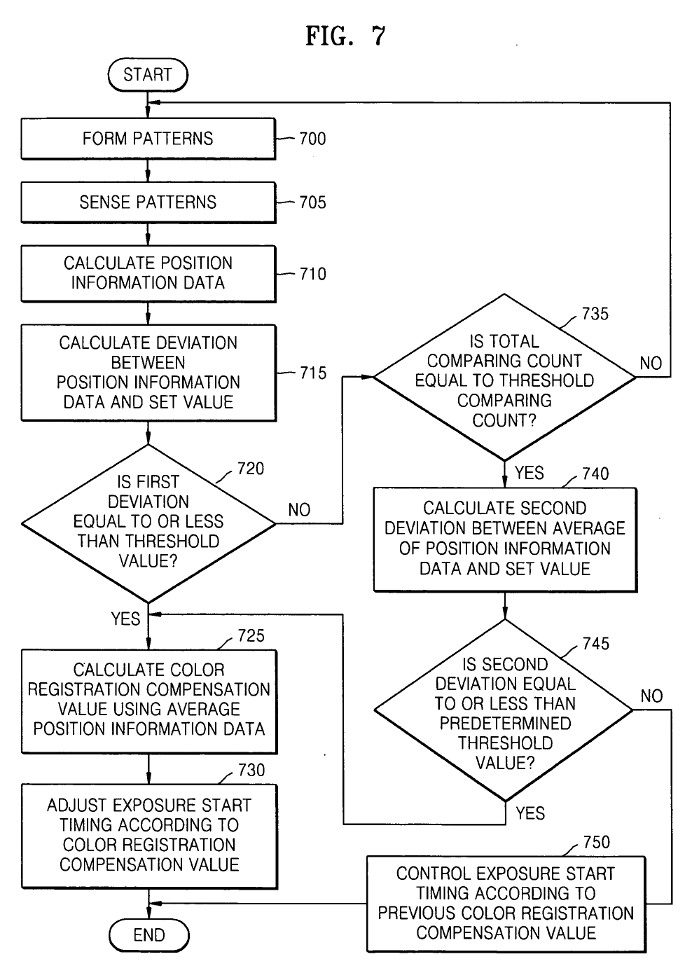

FIG. 7 is flowchart illustrating a color registration compensation for in an electro-photographic image forming apparatus, according to another embodiment of the present invention. The flowchart in FIG. 7 will be described with reference to FIGS. 2 and 3.

Operations 700 through 735 are the same as the operation 600 through 635, and thus will not be described.

If the total comparing count is equal to the threshold comparing count in operation 735, a second deviation between the average of the position information data and the set value is calculated in operation 740. If the second deviation is equal to or less than the predetermined threshold value in operation 745, the operation 725 is performed to calculate the color registration compensation value using the average of the position information data.

If the second deviation is greater than the predetermined threshold value in operation 745, the exposure start timing is controlled according to the previous color registration compensation value in operation 750.

The embodiments of the present invention can be written as computer programs and can be implemented in general-use digital computers that execute the programs using a computer readable recording medium. Examples of the computer readable recording medium include magnetic storage media, optical recording media, and remote storage media. Exemplary magnetic storage media includes ROM, floppy disks, hard disks, or the like. Exemplary optical recording media includes CD-ROMs, DVDs, or the like. Exemplary remote storage media includes transmission through the internet. The computer readable recording medium can also be distributed over network coupled computer systems so that the computer readable code is stored and executed in a distributed fashion. Functional programs, codes, and code segments for realizing the embodiments of the present invention can be easily modified by those of ordinary skill in the art.

According to the embodiments of the present invention, although instrumental jitter or slip is generated in the photoconductor drum or the transfer belt when the color registration compensation is performed, the color registration compensation value can be accurately calculated.

While the invention has been shown and described with reference to certain embodiments thereof, it will be understood by those skilled in the art that various changes in form and details may be made therein without departing from the spirit and scope of the invention as defined by the appended claims and their equivalents.

1. A color registration compensation apparatus for an electro-photographic image forming apparatus, the apparatus comprising:
an exposing unit for forming a plurality of latent images of patterns onto photoconductive drums, wherein at least two of the latent images are comprised of different colors;
a developing unit for developing the latent images of the patterns;
a pattern sensing unit for sensing the patterns transferred onto a transfer belt after the development; and
a color registration control unit for calculating position information data each time the patterns are sensed, for calculating a deviation between the position information data and a set value, for calculating a color registration compensation value using the position information data when the deviation is equal to or less than a threshold value, and for then controlling exposure start timings.

2. The apparatus of claim 1, wherein the color registration control unit controls the exposing unit to reform the patterns when the deviation is greater than the threshold value.

3. The apparatus of claim 1, wherein the position information data comprises position information data in a main scanning direction and position information data in a subsidiary scanning direction.

4. The apparatus of claim 1, wherein the color registration control unit comprises:
a position information data calculating unit for calculating position information data each time the patterns are sensed;
a deviation calculation unit for calculating a deviation between the position information data and a set value;
a comparison unit for comparing the deviation and a threshold value;
a compensation value calculating unit for calculating a color registration compensation value using the position information data when the deviation is equal to or less than the threshold value based on the comparison result; and
an exposure start timing control unit for controlling the exposure start timings according to the color registration compensation value.

5. The apparatus of claim 4, wherein the color registration control unit further comprises:
a compensation value storing unit for storing the calculated color registration compensation value,
wherein the color registration control unit controls the exposure start timings according to the previous color registration compensation value stored in the compensation value storing unit when the total comparing count of the comparison unit is equal to a threshold comparing count.

6. The apparatus of claim 1, wherein the plurality of latent images comprise yellow, magenta, cyan, and black latent images.

7. A color registration compensation method for an electro-photographic image forming apparatus, the method comprising:
forming a plurality of latent images of patterns onto photoconductive drums, wherein at least two of the latent images are comprised of different colors;
developing the latent images of the patterns formed on the photoconductive drums and transferring the patterns to the transfer belt;
sensing the patterns transferred to the transfer belt; and
calculating position information data each time the patterns are sensed, calculating a deviation between the position information data and a set value, calculating a color registration compensation value using the position information data when the deviation is equal to or less than a threshold value, and then controlling exposure start timings.

8. The method of claim 7, wherein, in the controlling of the exposure start timings, when the first deviation is greater than the threshold value, the latent images are formed.

9. The method of claim 7, wherein the position information data comprises position information data in a main scanning direction and position information data in a subsidiary scanning direction.

10. The method of claim 7, wherein the controlling of the exposure start timings comprises:
calculating the position information data each time the patterns are sensed;
calculating a first deviation between the position information data and a set value;
comparing the first deviation and a threshold value;
calculating a color registration compensation value when the first deviation is equal to or less than the predetermined threshold value based on the comparison results; and
controlling the exposure start timings according to the color registration compensation value.

11. The method of claim 10, wherein the controlling of the exposure start timings further comprises:
controlling the exposure start timings according to the previous color registration compensation value when the total comparing count is equal to the threshold comparing count.

12. The method of claim 10, wherein, when the total comparing count is equal to a threshold comparing count, the controlling of the exposure start timings further comprises:
calculating a second deviation between an average of the position information data and the set value;
comparing the second deviation with the threshold value; and
calculating a color registration compensation value using the position information data when the second deviation is equal to or less than the threshold value based on the comparison result.

13. The method of claim 12, wherein the controlling of the exposure start timings further comprises:
controlling the exposure start timings according to the previous color registration compensation value when the second deviation is greater than the threshold value.

14. The method of claim 7, wherein the plurality of latent images comprise yellow, magenta, cyan, and black latent images.

15. A computer-readable recording medium having recorded thereon a program for implementing a color registration compensation method for an electro-photographic image forming apparatus, the method comprising:
forming a plurality of latent images of patterns onto photoconductive drums, wherein at least two of the latent images are comprised of different colors;
developing the latent images of the patterns formed on the photoconductive drums and transferring the patterns to the transfer belt;
sensing the patterns transferred to the transfer belt; and
calculating the position information data each time the patterns are sensed, calculating a first deviation between the position information data and a set value, calculating a color registration compensation value using position information data when the first deviation is equal to or less than the threshold value, and then controlling exposure start timing.

16. The method of claim 15, wherein the plurality of latent images comprise yellow, magenta, cyan, and black latent images.

17. A color registration compensation apparatus for an electro-photographic image forming apparatus, the apparatus comprising:
means for forming a plurality of latent images of patterns onto photoconductive drums, wherein at least two of the latent images are comprised of different colors;
means for developing the latent images of the patterns;
means for sensing the patterns transferred onto a transfer belt after the development; and
color registration control means for calculating position information data each time the patterns are sensed, for calculating a deviation between the position information data and a set value, for calculating a color registration compensation value using the position information data when the deviation is equal to or less than a threshold value, and for then controlling exposure start timings.

18. The apparatus of claim 17, wherein the patterns are controlled to reform when the deviation is greater than the threshold value.

19. The apparatus of claim 17, wherein the position information data comprises position information data in a main scanning direction and position information data in a subsidiary scanning direction.

20. The apparatus of claim 17, wherein the color registration control means comprises:
means for calculating position information data each time the patterns are sensed;
means for calculating a deviation between the position information data and a set value;
means for comparing the deviation and a threshold value;
means for calculating a color registration compensation value using the position information data when the deviation is equal to or less than the threshold value based on the comparison result; and
means for controlling the exposure start timings according to the color registration compensation value.

21. The apparatus of claim 17, wherein the color registration control means further comprises:
means for storing the calculated color registration compensation value,
wherein the exposure start timings are controlled according to the previous color registration compensation value stored when the total comparing count is equal to a threshold comparing count.

22. The apparatus of claim 17, wherein the plurality of latent images comprise yellow, magenta, cyan, and black latent images.
